(19) United States
(12) Patent Application Publication
(10) Pub. No.: US 2025/0256279 A1
(43) Pub. Date: Aug. 14, 2025

(54) MICROFLUIDIC SYSTEMS AND METHODS FOR PROGRAMMABLE CONTROL OF MICRO-OBJECTS USING MEMBRANE DISPLACEMENT TRAPS

(71) Applicant: UNIVERSITY OF MARYLAND, COLLEGE PARK, College Park, MD (US)

(72) Inventors: Donald Lad DEVOE, Bethesda, MD (US); Jason HARRIOT, Bethesda, MD (US); Michael YEH, Germantown, MD (US)

(21) Appl. No.: 19/052,810

(22) Filed: Feb. 13, 2025

Related U.S. Application Data
(60) Provisional application No. 63/552,758, filed on Feb. 13, 2024.

(51) Int. Cl. B01L 3/00

(52) U.S. Cl. CPC B01L 3/5085; B01L 3/502715; B01L 2200/143; B01L 2300/023; B01L 2300/025; B01L 2300/0829

(57) ABSTRACT

A system for programmable control of micro-objects, such as droplets or particles, can include a microfluidic chip, a membrane displacement trap (MDT) actuation system, a pump connected to the microfluid chip, a detection system, and a control system. The microfluidic chip can have a microfluidic network with a main channel and a plurality of MDTs fluidically coupled to the main channel. The MDT actuation system can selectively actuate the plurality of MDTs, and the pump can pump a fluid into the microfluidic network. The detection system can detect a position of the micro-objects within the microfluidic chip. The control system can control the MDT actuation system and the pump to provide an operation on at least one of the micro-objects based on data received from the detection system. The operation can include generating, capturing, splitting, releasing, and/or merging of the at least one of the micro-objects.

### CROSS-REFERENCE TO RELATED APPLICATION

The present application claims the benefit of and priority under 35 U.S.C. § 119(e) to and is a non-provisional of U.S. Provisional Application No. 63/552,758, filed Feb. 13, 2024, entitled “Programmable Control of Droplets and Particles Using Membrane Displacement Traps,” which is hereby incorporated by reference herein in its entirety.

### STATEMENT REGARDING FEDERALLY SPONSORED RESEARCH

This invention was made with government support under R01 AI153564, R01 GM130923, and R21 AI161501 awarded by the National Institutes of Health. The government has certain rights in the invention.

### STATEMENT REGARDING PRIOR DISCLOSURE

Pursuant to 35 U.S.C. § 102(b)(1)(A), the following was published by the instant inventors, which is incorporated by reference herein in its entirety:

HARRIOT et al., “Programmable Control of Nanoliter Droplet Arrays Using Membrane Displacement Traps,” Advanced Materials Technologies, Nov. 10, 2023 (available online Aug. 15, 2023), 8(21):2300963.

### FIELD

The present disclosure relates generally to microfluidic systems and methods, and more particularly, the use of membrane displacement traps and/or an H-bridge circuit, for example, for control of and/or performing operations on micro-objects.

### BACKGROUND

Droplet-based microfluidic platforms offer powerful capabilities for discretizing and manipulating small aqueous sample volumes, with broad applications across the fields of chemistry, materials, biology, and biomedicine. Droplet microfluidics technology has been particularly impactful in the development of novel biological and biomolecular assays, with the compartmentalization of individual sample volumes enabling platforms for applications such as digital PCR, whole genome amplification, single-cell RNA sequencing, combinatorial biology, and high throughput screening. These assays typically rely on the generation of a set of monodisperse droplets in the nanoliter or sub-nanoliter range that serve as parallel reaction volumes, with monitoring of the chemical or biological reactions performed in a static chamber or in a continuous-flow channel via flow cytometry.

Given their advantages over alternative methods of sample discretization, including low sample volumes, reliable droplet generation with precise and uniform volume control, and integration with other microfluidic capabilities, there is significant interest in expanding the range of functional operations that can be performed within droplet microfluidic platforms. For example, the ability to controllably position individual micro-objects within a microfluidic flow network, and manipulate their interactions with other micro-objects, could open the door to new capabilities for assay design and implementation. However, prior techniques remain deficient in terms of micro-object control and customization, especially for small volumes. For example, electrowetting-on-dielectric (EWOD) technology, in which droplet surface tension gradients are modulated using electrical biases to mobilize droplets over a planar substrate, requires the use of large droplet volumes (e.g., in the microliter to milliliter range) for effective electrowetting-based actuation. While some prior microfluidic systems are capable of droplet capture and merging using passive or active techniques, the ability to provide arbitrary user-defined manipulation of discretized nanoliter-scale sample volumes remains limited.

Embodiments of the disclosed subject matter may address one or more of the above-noted problems and disadvantages, among other things.

### SUMMARY

Embodiments of the disclosed subject matter provide programmable control of micro-objects within a microfluidic system or network (e.g., chip) using a plurality (e.g., array) of membrane displacement traps (MDTs). In some embodiments, programmable deterministic control over complex operations can be achieved, for example, via software control over user-defined combinations of droplet generation, capture, ejection, sorting, splitting, and merging sequences, which can enable, among other features, the design of flexible assays employing nanoliter-scale fluid volumes. In some embodiments, a detection system (e.g., a computer vision system) can be used to detect positions of micro-objects within the microfluidic network, for example, to allow automated performance of user-defined operations on micro-objects.

In one or more embodiments, a system can comprise a microfluidic chip, an MDT actuation system, a pump, a detection system, and a control system. The microfluidic chip can comprise a microfluidic network, and a plurality of MDTs. The microfluidic network can comprise a main channel, and the plurality of MDTs can be fluidically coupled to the main channel. The MDT actuation system can be configured to selectively actuate the plurality of MDTs. The pump can be fluidically connected to the microfluidic chip and can be configured to pump a fluid into the microfluidic network. The detection system can be configured to detect a position of one or more micro-objects within the microfluidic chip. The control system can be operatively coupled to the MDT actuation system, the pump, and the detection system. The control system can be configured to control the MDT actuation system and the pump to provide an operation on at least one of the one or more micro-objects based at least in part on data received from the detection system. The operation can include generating, capturing, splitting, releasing, and/or merging of the at least one of the one or more micro-objects.

In one or more embodiments, a system can comprise a microfluidic network and an H-bridge actuation system. The microfluidic network can comprise a first channel and an H-bridge circuit formed by a plurality of second channels fluidically coupled to the first channel. The H-bridge actuation system can be coupled to the H-bridge circuit and can be constructed to control operation of the H-bridge circuit. A first input channel of the plurality of second channels can be coupled between a first end of the first channel and an inlet to the microfluidic network. A second input channel of the plurality of second channels can be coupled between a second end of the first channel and the inlet. A first output channel of the plurality of second channels can be coupled between the first end of the first channel and an outlet from the microfluidic network. A second output channel of the plurality of second channels can be coupled between the second end of the first channel and the outlet.

In one or more embodiments, a method can comprise detecting, via a detection system, a position of one or more micro-objects within a microfluidic chip. The microfluidic chip can comprise a microfluidic network and a plurality of membrane displacement traps (MDTs). The microfluidic network can comprise a main channel. Each MDT can be coupled to the main channel. The method can further comprise controlling, via a control system operatively coupled to the detection system, fluid flow through the main channel and actuation of one or more of the plurality of MDTs to perform an operation on at least one of the one or more micro-objects based at least in part on the detecting. The operation can include generating, capturing, splitting, releasing, or merging of the at least one of the one or more micro-objects.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram showing an exploded view of a structure for a single membrane displacement trap (MDT), according to one or more embodiments of the disclosed subject matter.

FIG. 1B is a simplified schematic diagram illustrating aspects of droplet capture and release, according to one or more embodiments of the disclosed subject matter.

FIG. 1C are simplified schematic diagrams illustrating aspects of various MDT unit operations (with continuous phase flow in each panel being from left to right), according to one or more embodiments of the disclosed subject matter.

FIG. 2A are simplified schematic diagrams illustrating different configurations of an H-bridge circuit for bi-directional fluid flow control, according to one or more embodiments of the disclosed subject matter.

FIG. 2B are simplified schematic diagrams illustrating another microfluidic H-bridge circuit for controlling the direction of fluid flow through an MDT array, according to one or more embodiments of the disclosed subject matter.

FIGS. 2C-2D show images of bidirectional flow through a fabricated chip similar to the configuration of FIG. 2B.

FIG. 2E is a simplified schematic diagram illustrating another configuration of an H-bridge circuit for bi-directional fluid flow control, according to one or more embodiments of the disclosed subject matter.

FIG. 2F is a simplified schematic diagram illustrating an array of H-bridge circuits for further controlling micro-object movement between various MDTs, according to one or more embodiments of the disclosed subject matter.

FIG. 3A is a simplified schematic diagram of a system for programmable control of micro-objects using MDTs, according to one or more embodiments of the disclosed subject matter.

FIG. 3B shows aspects of an exemplary software configuration for operation of a system for programmable control of micro-objects, according to one or more embodiments of the disclosed subject matter.

FIG. 3C shows an exemplary graphical user interface for controlling operation of a system for programmable control of micro-objects, according to one or more embodiments of the disclosed subject matter.

FIG. 3D depicts a generalized example of a computing environment in which the disclosed technologies may be implemented.

FIG. 4A is a simplified schematic diagram illustrating an exemplary configuration for an MDT system employing vision-based control and pneumatic actuators for on-chip valve operation.

FIG. 4B shows an experimental setup according to the configuration of FIG. 4A.

FIG. 5A illustrates geometric parameters used for droplet characterization before (left) and after (right) a partial droplet capture event.

FIG. 5B is a graph illustrating volume domains based on droplet morphology, in particular, for small spherical droplets, intermediate circular discs, and large elongated plugs within a 100-μm wide and 40-μm tall channel.

FIG. 6A are images from an experiment showing aspects of droplet generation at increasing valve dwell times.

FIG. 6B are images from another experiment showing aspects of a two-stage droplet ejection process, where: in (A), a captured droplet is ready for ejection; in (B), the pressure is first increased to 3.5 psi to partially eject the droplet, to prevent droplet splitting when ejecting larger droplets; in (C), the droplet is monitored to determine when the tail nears the trap exit; and, in (D), the pressure is increased to 20 psi, leading to complete droplet ejection.

FIG. 7A is a graph of experimental results showing complete capture of small droplets with Vₒ<Vₜᵣₐₚ (n=372).

FIG. 7B is a graph of experimental results showing captured volumes from droplets with initial volumes larger than the static trap volume (Vₒ>Vₜᵣₐₚ), resulting in droplet splitting (n=650).

FIG. 7C is a graph of experimental results showing satellite droplets resulting from the subset of partial capture events in FIG. 7B, where the trap is filled above 80% of its static volume (n=225).

FIG. 7D is a graph of experimental results showing droplet volumes generated via splitting of an initial sample plug by oil ejected from a trap (n=312).

FIGS. 7E-7F are graphs mapping the operational regimes defining the domains where splitting occurs for partial capture and oil ejection, respectively.

FIG. 8A is an image showing experimental results for droplets with pH sensitive dye processed to provide a logarithmic 7-step pH ladder ranging from pH 6 to pH 10.2.

FIG. 8B is a graph of dye intensity values from each trap in FIG. 8A, given by the average value of the red and green image channels.

FIG. 9A are images from an experiment showing a custom sequence of capture and ejection steps employing bidirectional flows, where droplets containing either red or green dye are moved between different traps and then merged pairwise to yield 3 identical mixed volumes in panel (H).

FIG. 9B illustrates aspects of a performed experiment for a droplet merging process, wherein: in panel (A), a green droplet approaches the target trap containing a red droplet; in panel (B), when the center of the green droplet reaches the centerline of the trap (t=0 s), the MDT control line is actuated with 2.5 psi pressure, partially ejecting the red droplet from the trap; in panels (C)-(E), the pressure is returned to 0 psi, pulling both droplets into the trap; and, in panel (F), droplet mixing occurs.

### DETAILED DESCRIPTION

### General Considerations

For purposes of this description, certain aspects, advantages, and novel features of the disclosed subject matter are described herein. The disclosed methods and systems should not be construed as being limiting in any way. Instead, the present disclosure is directed toward all novel and nonobvious features and aspects disclosed herein, alone and in various combinations and sub-combinations with one another. The methods and systems are not limited to any specific aspect or feature or combination thereof, nor do the disclosed aspects require that any one or more specific advantages be present, or problems be solved. The technologies from any aspect or example can be combined with the technologies described in any one or more of the other aspects or examples. In view of the many possible aspects to which the principles of the disclosed technology may be applied, it should be recognized that the illustrated aspects of the disclosure are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing aspects from discussed prior art, the numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Micro-Object: A droplet, cell, particle, nanotube, and/or other distinct object having a cross-sectional dimension of 1-mm or less (e.g., on the order of microns or sub-micron) and/or a volume of 1-μL or less (e.g., on the order of nanoliters or sub-nanoliter) and/or capable of movement within a microfluidic network (or at least within a channel therein).

Microfluidic: As generally used herein, microfluidic refers to fluid-based operations (e.g., liquid such as oil or water) performed in one or more conduits having a cross-sectional dimension of 1-mm or less (e.g., on the order of microns or sub-micron) and/or involving fluid volumes of 1-mL or less (e.g., on the order of microliters, nanoliters, or sub-nanoliter), as well as one or more channels, one or more networks (e.g., combination of channels), and/or one or more systems (e.g., combination of networks and/or fluid control components) for performing such operations.

### Introduction

Disclosed herein are systems and methods for programmable control of micro-objects within a microfluidic network using a plurality of membrane displacement traps (MDTs), for example, to enable custom processing (e.g., movement, capture, splitting, merging, etc.) of one or more micro-objects. Embodiments of the disclosed subject matter can offer flexible and deterministic control over the location and state of individual nanoliter-scale droplets. Alternatively or additionally, embodiments of the disclosed subject matter can allow complex sequences of discretization, metering, and mixing operations to be performed, for example, in a manner analogous to robotic stations employing automated pipetting for fluid control. In some embodiments, the platform can leverage MDT elements that allow direct modulation of trap volume to capture, split, meter, merge, mix, and/or eject selected micro-objects. In some embodiments, an array of individually-addressable MDTs can be combined with multiple sample inlets supporting dynamic on-demand micro-object generation.

In some embodiments, an H-bridge circuit (e.g., channel and valve topology) can be used to enable bidirectional flow control, for example, for arbitrary micro-object positioning within a microfluidic system. The H-bridge circuit can enable rapid switching of fluid flow direction within the microfluidic network (or at least a channel in the network or section thereof) and/or more precise control of flow switching dynamics (e.g., with minimal, or at least reduced, dead volume). In embodiments employing a plurality of MDTs, the use of an H-bridge circuit can also allow micro-objects to be transported to arbitrary trap locations with increased operational flexibility.

In some embodiments, a microfluidic system employing MDTs and/or an H-bridge circuit can be automated (e.g., a fully automated microfluidic platform). For example, the microfluidic system can be configured to perform unit operations (e.g., predetermined and stored in computer memory and/or responsive to input from a user or operator of the system) with automated feedback control. In some embodiments, the microfluidic system can employ a detection system (e.g., vision system) capable of automated micro-object tracking and/or closed-loop control of H-bridge and/or MDT operation (e.g., control of on-chip valves. Alternatively or additionally, in some embodiments, sequences of individual micro-object handling steps can be defined in software and/or can be selected by a user (e.g., with modular steps selected to define a custom sequence of steps). For example, a scripting language (e.g., Python-based scripting language) can provide control over user-defined micro-object sequences, with optimized timing of the on-chip actuation elements enabling precise control over each process step (e.g., without requiring active user control or intervention). By enabling automated software control over all (or at least some) operations, the potential of microfluidics for diverse biological and biochemical applications can be expanded, for example, by combining the functionality of conventional robotic liquid handling with the advantages of droplet-based fluid manipulation.

### Membrane Displacement Trap (MDT) Examples

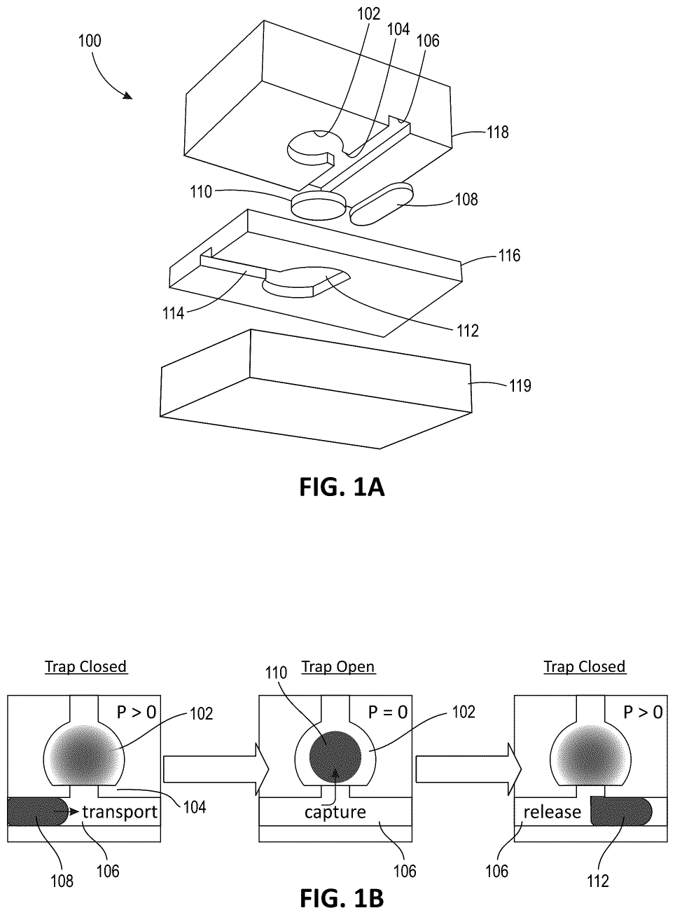

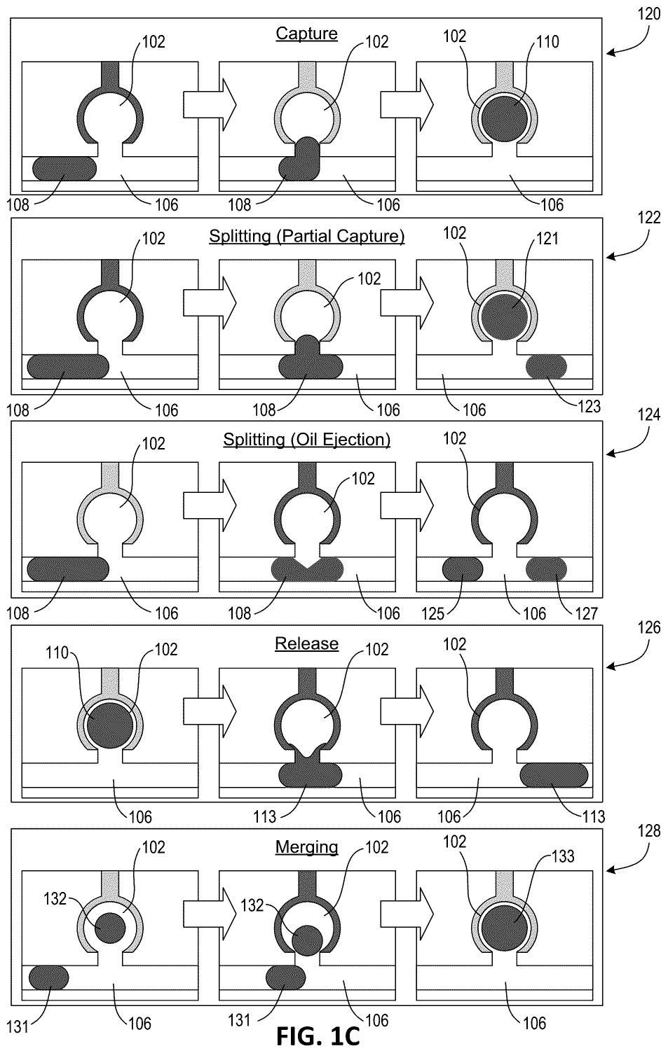

In some embodiments, a microfluidic system can include at least one membrane displacement trap (MDT), for example, a plurality of MDTs (e.g., arranged in an array). Each MDT can be formed in and/or comprise a part of a microfluidic chip, for example, a multi-layer microfluidic chip. For example, FIG. 1A shows a configuration of a single MDT element in a microfluidic chip 100 formed by and/or comprising a base layer 119, a fluidic layer 118, and a control layer 116 disposed between the base and fluidic layers. The layers are coupled (e.g., bonded and/or glued) together to form an integral structure, where structures (e.g., recesses) within the respective layers form and/or define channels, lines, membranes, and/or other microfluidic features. For example, the control layer 116 has recesses therein that, when coupled to the base layer 119, define a pressure line 114 and a membrane 112 of the MDT element. Similarly, the fluidic layer 118 has recesses therein that, when coupled to the control layer 116, define a well 102 (e.g., a substantially circular well, for example, having a diameter of 200-μm) of the MDT element, a main channel 106, and a neck 104 connecting the well 102 to the main channel 106. In some embodiments, at least one of the base layer 119, the control layer 116, and the fluidic layer 118 can be formed of and/or comprise a material different than the others. For example, the base layer 119 can be composed of a more rigid and/or gas-impermeable material (e.g., glass), while the control layer 116 and/or the fluidic layer 118 can be formed of a more flexible or gas-permeable (e.g., elastomeric polymer and/or oxygen-permeable polymer, such as but not limited to polydimethylsiloxane (PDMS)) material.

The well 102 and the membrane 112 are arranged with respect to each other (e.g., in a plan view), such that, when pressure (e.g., hydraulic or pneumatic) is applied to the pressure line 114, the membrane 112 deforms into the well 102 (and optionally part of neck 104) to displace fluid therein, with the resulting volume change in the well 102 being a function of the applied pressure in line 114. For example, FIG. 1B illustrates exemplary operations of an MDT element. In the left panel, a plug 108 initially travels in main channel 106 and well 102 of the MDT element is in a closed configuration, for example, with pressure applied to the pressure line causing membrane 112 to occupy the volume of well 102 such that fluid cannot enter well 102. As shown in the center panel of FIG. 1B, releasing the pressure allows the membrane 112 to retract from the well 102, causing part or all of traveling plug 108 to be captured from the main channel 106 and retained within well 102 as captured droplet 110 (e.g., with neck 104 designed to prevent the captured droplet from being entrained in the flow in the main channel 106 prior to desired release). All or part of the captured droplet 110 can then be released from the MDT element by applying pressure to the pressure line, such that the membrane 112 again deflects into the well 102, thereby ejecting the droplet into the main channel 106 as released plug 113, as shown in the right panel of FIG. 1B.

The simple process of FIG. 1B can be adapted to provide more complex operations, for example, by regulating the timing of applied pressure to the pressure line, the magnitude of the applied pressure, the timing of flow through the main channel, and/or the flow rate through the main channel. For example, FIG. 1C illustrates the operations of droplet capture 120, droplet splitting via partial capture 122, droplet splitting without partial capture 124 (e.g., via ejection of fluid, such as oil), droplet release 126 (e.g., in a manner similar to that described above for FIG. 1B), and droplet merging 128. The capture operation 120 can involve capturing some or all of plug 108 traveling in main channel 106 within well 102 as captured droplet 110, for example, by partial or full retraction of the membrane from well 102. Similarly, the release operation 126 can involve ejecting some or all of captured droplet 110 from the well 102 to form plug 113 in main channel 106, for example, by partial or full actuation of the membrane into well 102. In some embodiments, the capture operation 120 and/or the release operation 126 can be performed in a manner similar to that described above for FIG. 1B.

The splitting operation 122 can involve capturing only part of plug 108 from main channel 106 within well 102 as captured droplet 121, while the remaining plug 123 is retained within the main channel 106. In some embodiments, the splitting operation 122 can be a function of the volume of plug 108 and the volume of the well 102. For example, the volume of plug 108 may be larger than the volume of the well 102, such that well 102 is completely filled by the captured droplet 121. Alternatively or additionally, the volume of the well 102 (and thus the volume of the captured droplet 121 and the volume of the remaining plug 123) can be regulated, for example, by applying an appropriate pressure to the pressure line of the membrane to reduce a volume of the well 102 but without closing the MDT. In contrast, splitting operation 124 may achieve splitting without regard to the volume of the well 102. For example, the well 102 can be initially filled with fluid (e.g., oil) as the plug 108 travels along the main channel 106, and the fluid can be ejected at an intermediate portion of the plug 108 as it travels past, or is positioned with respect to, a neck of the MDT element, for example, by applying an appropriate pressure to the pressure line of the membrane to reduce a volume of the well 102. This fluid ejection can thus divide the plug 108 into separate portions 125, 127 within main channel 106.

The merging operation 128 can involve combining a plug 131 (or a portion thereof) with a previously captured droplet 132 to form a merged droplet 133 within well 102. In some embodiments, the merging operation 128 can be a function of the volumes of the plug 131, droplet 132, and well 102. For example, the volume of each of the plug 131 and droplet 132 can be less than the volume of the well 102, and the volume of the merged droplet 133 can be less than or equal to the volume of the well 102 (e.g., such that well 102 is completely filled by the merged droplet 133). In some embodiments, the well 102 may initially have a reduced volume, for example, by applying an appropriate pressure to the pressure line of the membrane to reduce a volume of the well 102 but without closing the MDT, and the previously captured droplet 132 can occupy this reduced volume. As the plug 131 passes the MDT, the membrane can be further retracted (e.g., by reducing the applied pressure) to increase the volume of the well 102 and thereby allow some or all of plug 131 to enter and combine with droplet 132, thereby forming merged droplet 133. Alternatively or additionally, the membrane can be further actuated (e.g., by increasing the applied pressure) to further reduce the volume of the well 102 and eject captured droplet 132 into plug 131. The droplet 132 and plug 131 can thus combine within the main channel 106. In some embodiments, the merged droplet 133 can then be recaptured from main channel 106 into well 102 (e.g., by reducing the applied pressure), or can be transported with the fluid flow in the main channel 106 without recapture.

The basic functionalities of FIG. 1C can be combined together and/or used in sequence to provide more complex control of droplets. Microfluidic operations for droplet control beyond those explicitly illustrated in FIG. 1C are also possible according to one or more contemplated embodiments. Although the description of FIG. 1C and elsewhere herein focuses on droplet control, embodiments of the disclosed subject matter are not limited thereto. Indeed, the disclosed techniques can be readily adapted to control of other micro-objects, according to one or more contemplated embodiments.

### H-Bridge Circuit Examples

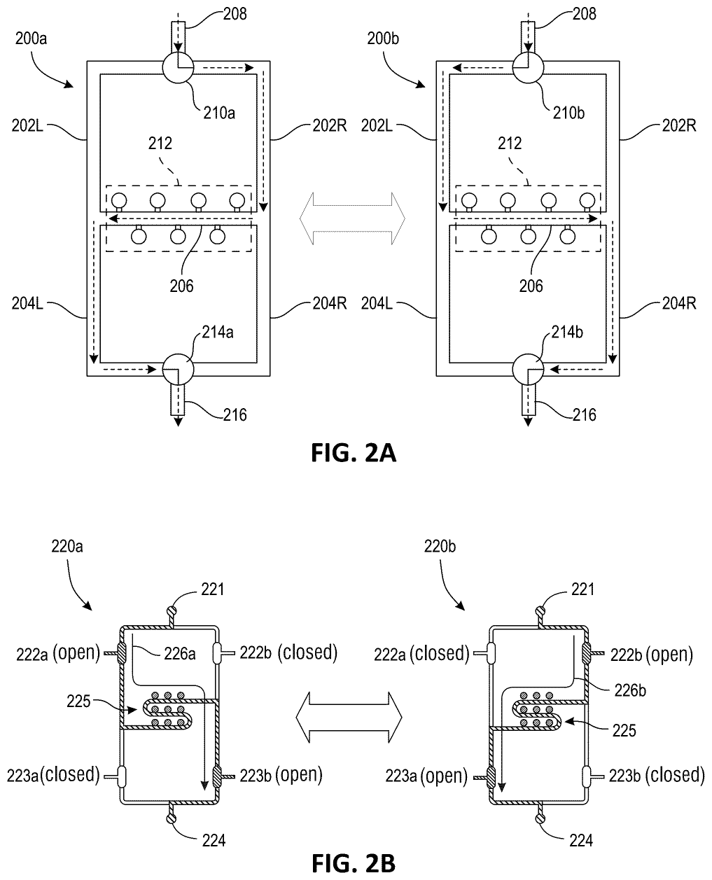

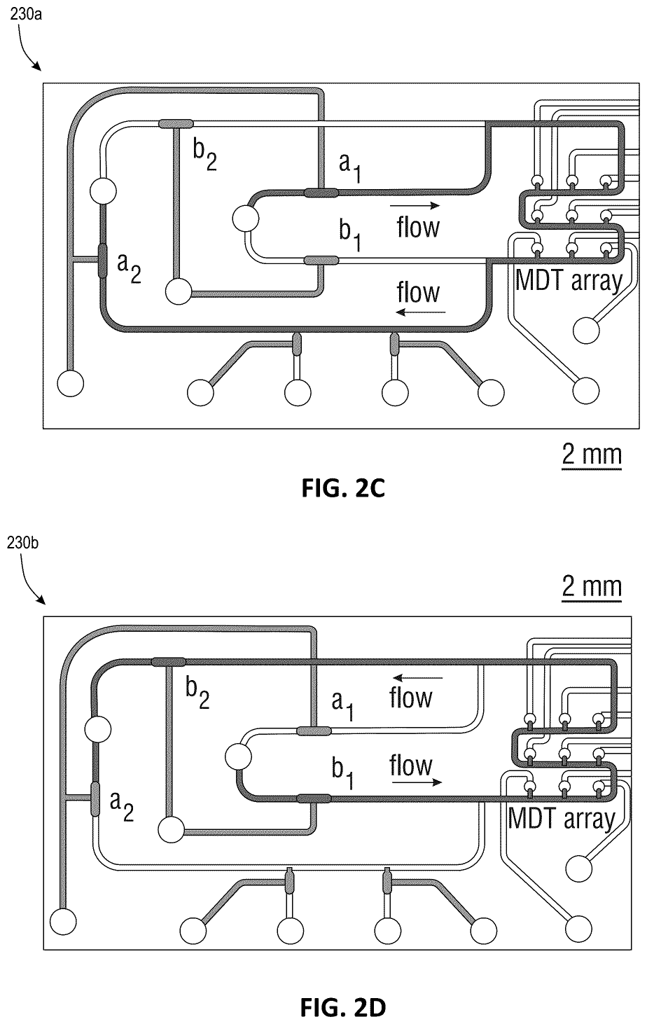

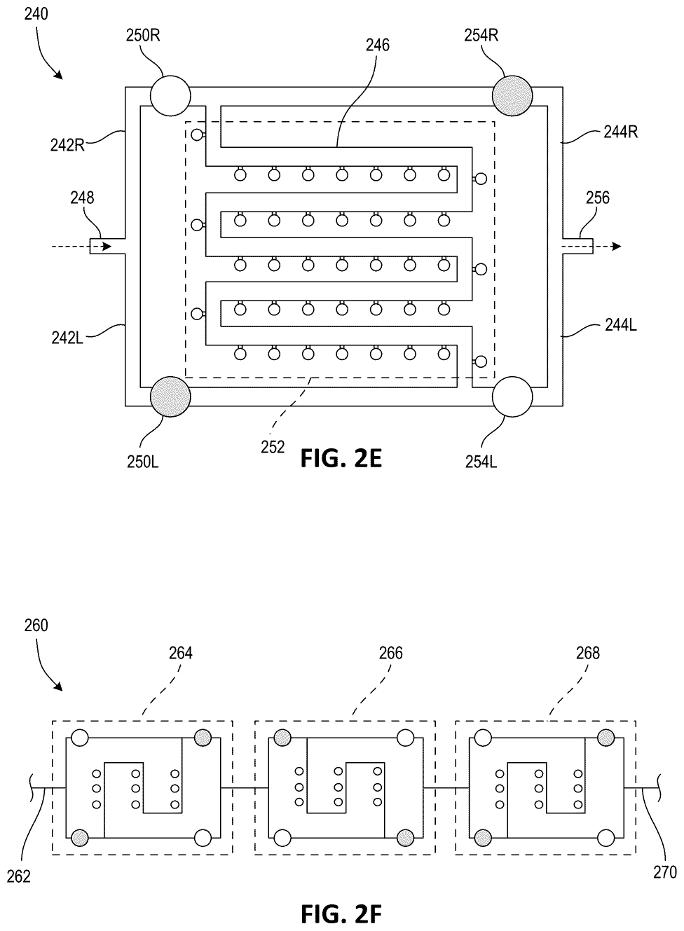

In some embodiments, a microfluidic network can include and/or channels thereof can form an H-bridge circuit, for example, to allow more rapid and/or more precise switching of flow direction within a channel (e.g., a main channel with a plurality of MDTs fluidically coupled thereto). For example, FIG. 2A illustrates different configurations for an H-bridge circuit to provide selectable (e.g., reversible) fluid flow within main channel 206. In the illustrated example, the main channel 206 is coupled to an MDT array 212; however, the H-bridge circuit can also be used to advantage in microfluidic networks without MDTs. Accordingly, embodiments of the disclosed subject matter are not limited to the use of an H-bridge circuit with MDTs.

In the illustrated example, the H-bridge circuit includes a first input channel 202L, a second input channel 202R, a first output channel 204L, a second output channel 204R, and a main channel 206. The main channel 206 can extend through and be in fluid communication with the MDT array 212. The first input channel 202L can provide a fluidic connection between an inlet 208 and a first end of the main channel 206 via an inlet valve, and the second input channel 202R can provide a fluidic connection between the inlet 208 and a second end of the main channel 206 (e.g., opposite the first end) via the inlet valve. Similarly, the first output channel 204L can provide a fluidic connection between an outlet 216 and the first end of the main channel 206 via an outlet valve, and the second output channel 204R can provide a fluidic connection between the outlet 216 and the second end of the main channel 206.

In a first mode of operation 200a, the inlet valve and the outlet valve adopt respective configurations 210a, 214a that cause fluid to flow from the inlet 208 to the outlet 216 via second input channel 202R and first output channel 204L. In a second mode of operation 200b, the inlet and outlet valves adopt opposite configurations 210b, 214b, respectively, that cause fluid to now flow from the inlet 208 to the outlet 216 via first input channel 202L and second output channel 204R. Thus, fluid flows from right to left along the main channel 206 in the first mode 200a, while fluid flows from left to right along the main channel 206 in the second mode 200b. In this manner, the H-bridge circuit can enable on-demand, rapid switching of flow direction through the main channel 206, while maintaining a single direction for fluid flow into inlet 208 and fluid flow from outlet 216.

Although FIG. 2A shows a single valve to direct the inlet flow between the first and second input channels and a single valve to direct the outlet flow between the first and second output channels, embodiments of the disclosed subject matter are not limited thereto. Rather, any number of valves can be employed to select between input/output channels and thereby change direction of flow within the main channel. For example, FIG. 2B illustrates an H-bridge circuit where the single valves at the inlet/outlet ends of FIG. 2A have been replaced with separate valve pairs. FIGS. 2C-2D illustrate a fabricated example of an H-bridge circuit according to the configuration of FIG. 2B. In some embodiments, the construction and operation of each valve for the H-bridge circuit may be similar to that employed for the MDT, for example, with a pressure line and membrane that deflects into, and thus blocks fluid from flowing through, a respective channel.

In a first mode of operation 220a (or 230a in FIG. 2C), valve 222a (a₁ in FIGS. 2C-2D) for a first input channel and valve 223b (a₂ in FIGS. 2C-2D) for a second output channel are opened, while valve 222b (b₁ in FIGS. 2C-2D) for a second input channel and valve 223a (b₂ in FIGS. 2C-2D) for a first output channel are closed, such that fluid flow through the MDT array 225 is along a first direction 226a. In a second mode of operation 220b (or 230b in FIG. 2D), valve 222a for the first input channel and valve 223b for the second output channel are closed, while valve 222b for the second input channel and valve 223a for the first output channel are opened, such that fluid flow through the MDT array 225 is now along a second direction 226b opposite the first 226a, even though the same inlet 221 and outlet 224 are used to provide the fluid flow. In some embodiments, the states of valves can be coupled together, for example, to simplify control and actuation. For example, valves 222a, 223b (a₁ and a₂ in FIGS. 2C-2D) can have a first common state, and valves 222b, 223a (b₁ and b₂ in FIGS. 2C-2D) can have a second common state opposite the first. In some embodiments, the actuation state for both pairs of valves can be defined using, for example, an off-chip 3-way pneumatic valve, allowing flow direction to be switched from a single control output.

FIG. 2A illustrates a simplified H-bridge circuit with a single straight main channel in communication with an array 212 of seven traps. However, other configurations for the main channel are also possible according to one or more contemplated embodiments, such as but not limited to the meandering or serpentine path for the channel through the MDT array in FIGS. 2B-2D. Moreover, although FIGS. 2A-2D illustrate a limited number and particular arrangement of traps in the MDT array, other numbers and/or arrangements are also possible. For example, FIG. 2E shows another H-bridge circuit 240 with a serpentine configuration for main channel 246 and a larger number of traps in MDT array 252. In the illustrated example, H-bridge circuit 240 includes first and second input channels 242R, 242L and first and second output channels 244R, 244L, each with a respective control valve 250R, 250L, 254R, 254L. As with the above described examples, selection of the states of valves 250R, 250L, 254R, 254L can change a direction of flow along main channel 246 (and through the MDT array 252) while the direction of flow into inlet 248 and from outlet 256 otherwise remains the same.

In some embodiments, multiple H-bridge circuits can be coupled together, for example, to provide additional control over micro-object operations. For example, FIG. 2F illustrates an array 260 of individual H-bridge circuits 264, 266, 268 coupled together between an inlet 262 and an outlet 270. The main channel configuration and/or MDT array can be the same or different for each H-bridge circuit. In some embodiments, the configuration of each H-bridge circuit can be independently controlled, for example, such that flow direction in one H-bridge circuit is different than others. Although FIG. 2F illustrates three H-bridge circuits, other numbers of H-bridge circuits coupled together are also possible according to one or more contemplated embodiments. Other configurations and combinations of H-bridge circuits are also possible. Indeed, arrangements and/or operations of H-bridge circuits and/or MDT arrays therein may only be limited by actuation system, for example, the pressure line to each valve and/or MDT to apply pressure for actuation thereof.

### Microfluidic System Examples

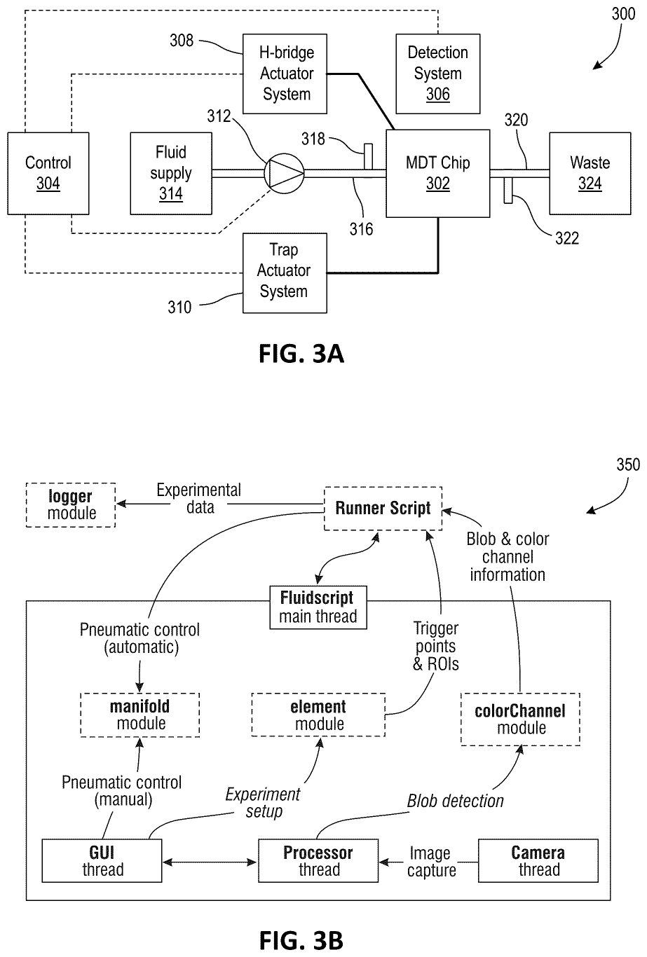

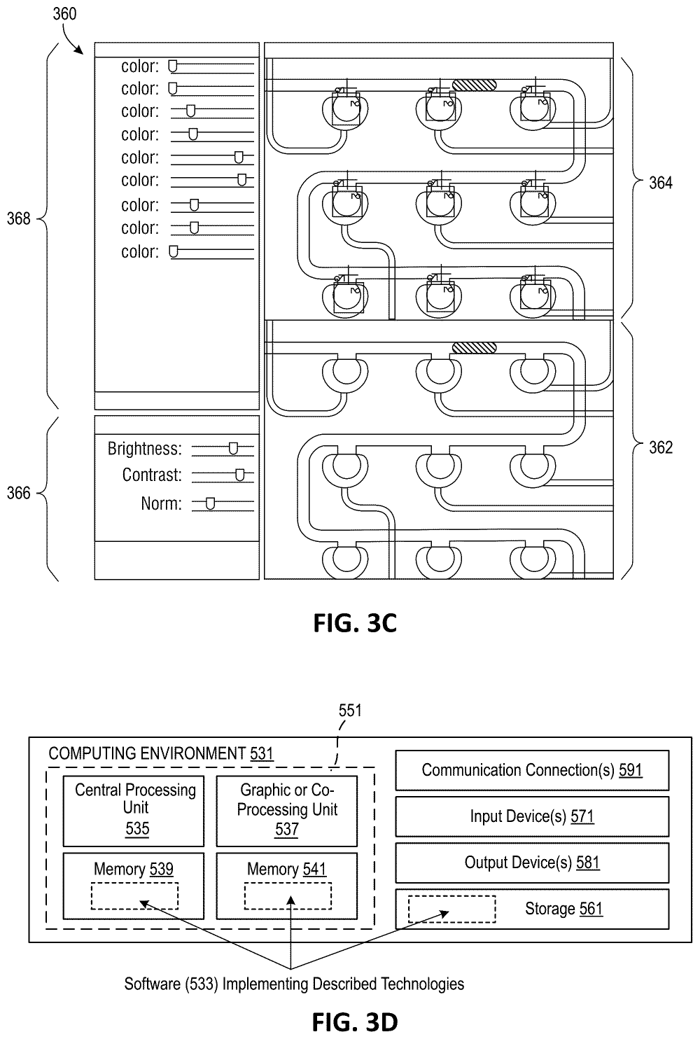

FIG. 3A illustrates a system 300 for programmable control of micro-objects using MDTs. In the illustrated example, system 300 includes a microfluidic chip 302, a control system 304, a detection system 306, an H-bridge actuator system 308, an MDT actuation system 310, and a pump 312 (e.g., syringe pump). In some embodiments, the system 300 can also include a fluid supply 314 (e.g., supply of oil, such as mineral oil or fluorinated oil) coupled to the pump 312 and a waste reservoir 324 (or drain). Pump 312 can pump fluid from fluid supply 314 to an inlet of the microfluidic chip 302 via input line 316, and fluid exiting from an outlet of the microfluidic chip 302 can be directed to the waste reservoir 324 via output line 320. Alternatively, in some embodiments, the fluid existing from the microfluidic chip 302 can be reused, for example, by returning to fluid supply 314 and/or recirculation to the inlet of the microfluidic chip 302.

In some embodiments, the input line 316 (or a portion of the microfluidic chip 302) can include means 318 for injecting a droplet and/or particle into the fluid. For example, the means for injecting can include one or more dynamic droplet generators (e.g., parallel droplet generators) for on-demand droplet production. In some embodiments, each dynamic droplet generator employs a T-junction combined with a membrane valve for injection of discrete aqueous volumes into an oil phase flowing within the main channel, which may provide precise control over injected aqueous volumes. In some embodiments, the use of independent plug generators can allow two different samples to be injected at desired time points. Additional generators may be readily integrated for applications requiring higher levels of sample multiplexing. Alternatively or additionally, in some embodiments, the output line 320 (or a portion of the microfluidic chip 302) can include means 322 for extracting a product (e.g., droplet and/or particle) from the flowing fluid. For example, the means for extracting can include a trap (e.g., MDT or otherwise), valve, switch, separation device, and/or separate flow channel that isolates the product from fluid proceeding to waste 324 (or recirculated to the microfluidic chip 302).

In the illustrated example, control system 304 is operatively coupled to the detection system 306, the H-bridge actuator system 308, the trap actuator system 310, and the pump 312. The detection system 306 can detect a position of one or more droplets and/or particles within the microfluidic network and/or the MDT array. In some embodiments, the detection system 306 can be and/or comprise a vision system, for example, employing a camera or imaging sensor (e.g., charge-coupled device (CCD), complementary metal-oxide-semiconductor (CMOS) device, etc.), an optical or electromagnetic radiation sensor (e.g., a photodetector, such as but not limited to a p-n photodiode, an avalanche photodiode, a metal-semiconductor-metal device, a photoconductor, a photomultiplier tube, a photovoltaic cell, and pyroelectric detector), an electrical sensor (e.g., Hall effect sensor, conductivity sensor, capacitance sensor, voltage sensor, etc.), and/or any other sensor capable of detecting droplet/particle position. For example, the detection system 306 can image at least part of the microfluidic chip 302, for example, at least part of the MDT array and/or the main channel.

The MDT actuation system 310 can selectively actuate one or more MDTs in the array, for example, by applying pressure (e.g., hydraulic or pneumatic) to a respective pressure line of the corresponding MDT to cause a membrane to deform into a well of the MDT, thereby displacing fluid from the well. The H-bridge actuator system 308 can selectively actuate one or more valves on, or in communication with, the microfluidic chip 302 so as to control a direction of fluid flow through the main channel and/or the MDT array. In some embodiments, the control system 304 can control the H-bridge actuator system, the MDT actuation system 310, and/or the pump 312 to provide one or more desired operations on one or more micro-objects within the microfluidic chip. Such operations can include, but are not limited to, generating, capturing, splitting, releasing, and/or merging of one or more micro-objects.

In some embodiments, the control system 304 can direct operation based at least in part on data received from the detection system (e.g., using closed loop control) and/or user input (e.g., via a graphical user interface). For example, FIG. 3B shows a control system configuration 350 for operating a microfluidic system to provide programmable control of one or more micro-objects that includes, in accordance with some embodiments, one or more modules, programs, software engines or processor instructions for performing at least some of the functionalities described herein. For example, control system configuration 350 may comprise one or more software module(s) or engine(s) for directing one or more processors of system 300 to perform certain functions. For example, the control system may employ Python-based code to perform automated droplet position and volume measurements, and to control all MDT actuator states in closed loop based on operational sequences specified in a user-defined script.

In some embodiments, software components, applications, routines or sub-routines, or sets of instructions for causing one or more processors to perform certain functions may be referred to as “threads,” “modules,” “scripts,” or “engines.” It should be noted that such threads, modules, scripts, engines, or any software or computer program referred to herein, may be written in any computer language and may be a portion of a monolithic code base, or may be developed in more discrete code portions, such as is typical in object-oriented computer languages. In addition, the threads, modules, scripts, engines, or any software or computer program referred to herein, may in some embodiments be distributed across a plurality of computer platforms, servers, terminals, and the like. For example, a given thread, module, script, or engine may be implemented such that the described functions are performed by separate processors and/or computing hardware platforms. Further, although certain functionality may be described as being performed by a particular thread, module, script, or engine, such description should not be taken in a limiting fashion. In other embodiments, functionality described herein as being performed by a particular thread, module, script, or engine may instead (or additionally) be performed by a different thread, module, script, engine, program, sub-routine, or computing device without departing from the spirit and scope of the disclosed subject matter.

It should be understood that any of the software modules, engines, threads, scripts, or computer programs illustrated herein may be part of a single program or integrated into various programs for controlling one or more processors of a computing device or system. Further, any of the software modules, engines, threads, scripts, or computer programs illustrated herein may be stored in a compressed, uncompiled, and/or encrypted format and include instructions which, when performed by one or more processors, cause the one or more processors to operate in accordance with at least some of the methods described herein. Of course, additional and/or different software modules, engines, threads, scripts, or computer programs may be included, and it should be understood that the examples illustrated and described with respect to FIG. 3B are not necessary in any embodiments. Use of the terms “thread,” “script,” “module,” or “software engine” is not intended to imply that the functionality described with reference thereto is embodied as a stand-alone or independently functioning program or application. While in some embodiments functionality described with respect to a particular thread, script, module, or engine may be independently functioning, in other embodiments such functionality is described with reference to a particular thread, script, module, or engine for case or convenience of description only and such functionality may in fact be a part of, or integrated into, another thread, script, module, engine, program, application, or set of instructions for directing a processor of a computing device.

In some embodiments, the instructions of any or all of the software modules, threads, scripts, engines, or programs described above may be read into a main memory from another computer-readable medium, such from a read-only memory (ROM) to random access memory (RAM). Execution of sequences of instructions in the software module(s), thread(s), script(s), engine(s), or program(s) can cause one or more processors to perform at least some of the processes or functionalities described herein. Alternatively or additionally, in some embodiments, hard-wired circuitry may be used in place of, or in combination with, software instructions for implementation of the processes or functionalities described herein. Thus, the embodiments described herein are not limited to any specific combination of hardware and software.

In the illustrated example of FIG. 3B, the control system configuration 350 includes a camera thread (e.g., to provide image capture(s) of the MDT chip), a processor thread (e.g., for detecting blobs within the capture images), a graphical user interface (GUI) thread (e.g., for receiving user input for defining an experimental routine and/or for providing manual control over system operation), a color channel module (e.g., for further detecting blob and color channel information in the captured images), an element module (e.g. for identifying trigger points and/or regions of interest (ROIs) based on a defined experimental routine), a manifold module (e.g., for providing pneumatic and/or hydraulic control for operation of one or more actuator systems), a runner script (e.g., for coordinating operation of the different components of the control system), and a logger module (e.g., for storing experimental data). In some embodiments, at least the camera thread, the processor thread, the GUI thread, the color channel module, the element module, and the manifold module may be considered part of a main thread (referred to herein as FluidScript). Other modules or components are also possible according to one or more contemplated embodiments.

When instantiated within a user script, the FluidScript code presented a user interface 360 (FIG. 3C) that includes raw video 362 of the MDT trap array, interfaces 366, 368 for adjusting detection (e.g., video) settings and threshold values to allow optimization of droplet imaging for different solutions and lighting conditions (e.g., brightness and contrast settings in interface 366; color filter settings in interface 368), and a filtered video feed 364 based on these settings. In some embodiments, the filtered video feed 364 can also serve as an interface allowing the user to define arbitrary reference points and ROIs that may be referenced in the script, for example, to create trigger points for valve actuation.

### Computer Implementation Examples

FIG. 3D depicts a generalized example of a suitable computing environment 531 in which the described innovations may be implemented, such as but not limited to control system 304, detection system 306 (and/or a vision system thereof), H-bridge actuator system 308, MDT actuation system 310, control system configuration 350, a system for generating the graphical user interface of FIG. 3C, computer 426, or a method for operating a system with MDTs and/or an H-bridge circuit. The computing environment 531 is not intended to suggest any limitation as to scope of use or functionality, as the innovations may be implemented in diverse general-purpose or special-purpose computing systems. For example, the computing environment 531 can be any of a variety of computing devices (e.g., desktop computer, laptop computer, server computer, tablet computer, etc.).

With reference to FIG. 3D, the computing environment 531 includes one or more processing units 535, 537 and memory 539, 541. In FIG. 3D, this basic configuration 551 is included within a dashed line. The processing units 535, 537 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 3D shows a central processing unit 535 as well as a graphics processing unit or co-processing unit 537. The tangible memory 539, 541 may be volatile memory (e.g., registers, cache, RAM), non-volatile memory (e.g., ROM, EEPROM, flash memory, etc.), or some combination of the two, accessible by the processing unit(s). The memory 539, 541 stores software 533 implementing one or more innovations described herein, in the form of computer-executable instructions suitable for execution by the processing unit(s).

A computing system may have additional features. For example, the computing environment 531 includes storage 561, one or more input devices 571, one or more output devices 581, and one or more communication connections 591. An interconnection mechanism (not shown) such as a bus, controller, or network interconnects the components of the computing environment 531. Typically, operating system software (not shown) provides an operating environment for other software executing in the computing environment 531, and coordinates activities of the components of the computing environment 531.

The tangible storage 561 may be removable or non-removable, and includes magnetic disks, magnetic tapes or cassettes, CD-ROMs, DVDs, or any other medium which can be used to store information in a non-transitory way, and which can be accessed within the computing environment 531. The storage 561 can store instructions for the software 533 implementing one or more innovations described herein.

The input device(s) 571 may be a touch input device such as a keyboard, mouse, pen, or trackball, a voice input device, a scanning device, or another device that provides input to the computing environment 531. The output device(s) 581 may be a display, printer, speaker, CD-writer, or another device that provides output from computing environment 531.

The communication connection(s) 591 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

### Materials and Reagents

Microfluidic chips were fabricated by soft lithography using polydimethylsiloxane (PDMS) elastomer (Sylgard 184, Dow Corning). To characterize trap performance, the aqueous phase consisted of red and green food dye (McCormick) dissolved 1:20 in deionized water. The continuous phase consisted of light mineral oil with the addition of 0.01% w/w Span 80 surfactant for all experiments, except where noted. For experiments evaluating the performance of droplet manipulation in fluorinated oil, FC-40 (3M) with 0.01% Fluosurf surfactant (Darwin Microfluidics) was used as the continuous phase. All fluidic chip connections were made using Tygon microbore tubing (0.51 mm ID, 1.52 mm OD, Cole-Parmer) connected to 24 gauge needle segments inserted in access holes within each microfluidic device.

### Microfluidic Chip Fabrication

The MDT array chips were fabricated by PDMS soft-lithography. The device had an upper fluidic layer with fluid channels and membrane displacement traps and a lower control layer containing hydraulic channels for trap and valve actuation attached to a glass slide to seal the control layer microchannels and serve as a rigid carrier for the assembly. Soft lithography molds for both the fluidic layer and control layer were prepared using silicon wafers patterned with SU-8 2015 photoresist (Kayaku). For both molds, the SU-8 was spin-coated at 500 rpm for 5 s, followed by 1150 rpm for 32 s, to yield a final feature height of 40 μm. To form the fluidic layer, PDMS (10:1 w/w base:curing agent) was poured over the corresponding silicon mold to a thickness of 5 mm, then cured in an oven at 80° C. for 25 min. Channel features in the fluidic layer were 100 μm wide, with circular trap features 200 μm in diameter yielding a trap volume of 1.3 nL. The PDMS was then peeled off the wafer and cut into individual device sections with a scalpel. To form the control layer, a thin film of PDMS (20:1 w/w base:curing agent) was formed on the mold wafer by spin-coating at 500 rpm for 10 s, followed by 1500 rpm for 60 s, yielding a final thickness of 65 μm. Channel features in the resulting control layer were 100 μm wide and capped with a 24.8 μm thick membrane. The wafer was then baked at 80° C. for 5-7 min to partially cure the PDMS until tacky. Before separating the control layer from its mold wafer, the fluidic layer sections were aligned and bonded to the partially cured hydraulic layer. After assembling all of the multilayer structures, the wafer was cured at 80° C. for 24 h before peeling the PDMS from the wafer. Fluidic inlet and outlet ports, together with hydraulic access ports, were formed with a 0.5 mm diameter punch. The control layer was sectioned with a scalpel to define the final chip dimensions, and the resulting chips were exposed to oxygen plasma for 30 s together with glass slides before pressing the surfaces together to facilitate a permanent bond. Finally, the devices were incubated at 80° C. for 24 h to restore native hydrophobicity to the PDMS surfaces following plasma treatment.

### Microfluidic System

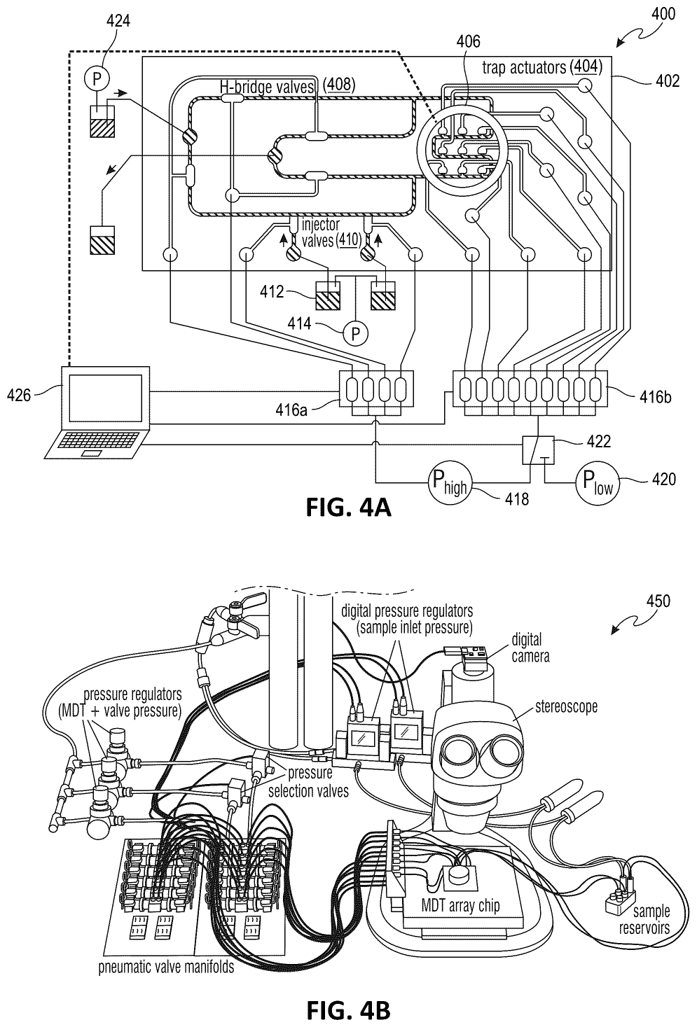

In a fabricated microfluidic system 400, a microfluidic chip 402 included an array of nine independent trap elements, two independent dynamic droplet generators, and a fluidic H-bridge circuit, as shown in the schematic of FIG. 4A. Operation of the array of MDTs was controlled by respective trap actuators 404, while operation of the H-bridge circuit was controlled by respective H-bridge valves 408. The H-bridge valves 408 were coupled to a high pressure source 418, and application of pressure to the valves 408 was controlled via a pneumatic valve manifold 416a. The trap actuators 404 were similarly coupled to high pressure source 418 via a pressure selection valve 422, and application of pressure to the actuators 404 was controlled via another manifold 416b. The pressure selection valve 422 allowed the pressure applied to the trap actuators 404 to be toggled between high pressure source 418 (e.g., to effect complete closure of an MDT via full displacement of the membrane into the well) and low pressure source 420 (e.g., to effect a reduction in volume of the well without closing the MDT via partial displacement of the membrane into the well).

Sample sources 412 were connected to the injector valves 410 of the microfluidic chip 402, and a pressure source 414 (e.g., syringe pump) was connected to the sample sources 412 to inject sample into the microfluidic network of the chip based on a state of the injector valves 410. The injector valves 410 were also coupled to the high pressure source 418, and application of pressure to the valves 410 was also controlled via pneumatic valve manifold 416a. An oil source was connected to the inlet of the microfluidic chip 402, and another pressure source 424 (e.g., syringe pump) was connected to the oil source to cause fluid to flow into and through the microfluidic network of the chip. Fluid exiting at an outlet of the chip 402 was collected in a waste container.

A digital-camera-based vision system 406 was used to image the MDT array during operation. Computer 426 was operatively coupled to the vision system 406, the manifolds 416a, 416b, and the pressure selection valve 422, and ran computer code for controlling operation of system 400. FIG. 4B shows additional details regarding the physical layout of a system 450 according to the configuration of FIG. 4A.

### Vision System

A See3Cam CU30 USB camera (e-con Systems) was mounted to the trinocular receptacle of an SMZ745T microscope (Nikon). A generic X-Y stage allowed positioning of the microfluidic device in the camera's field of view. A generic LED light source and diffuser illuminated the device from below. The vision system was implemented in Python 3 using the OpenCV computer vision library running on a desktop PC. Droplet tracking was achieved using color thresholding functions within OpenCV to resolve individual blobs. User-defined experiments were coded in Python and controlled using the provided graphical interface. The interface allowed individual control of traps, pressure valves, and thresholding settings. It also showed the live video feed, detected blobs, user-defined trigger elements, and diagnostic information.

### Pressure and Flow Control

Elastomer membrane valves in the control layer were actuated using pressure inputs delivered through a pair of manifolds each containing a set of 12 two-way solenoid-controlled pneumatic valves (Clippard). The manifold input pressure was controlled through a pair of gas regulators (9892K12, McMaster-Carr), each supplied with a high-pressure air line, and a three-way solenoid valve to allow switching between the regulator outputs. The manifold board was pneumatically interfaced with the microfluidic chip through urethane tubing (0.06 in ID, 0.13 in OD, Clippard) and 24-gauge needle segments (Hamilton) inserted into on-chip access holes. Control over the continuous-phase oil flow rate was achieved using an electronic pressure regulator (EPR-150, 0-150 psi range, Equilibar) to pressurize the head space of an off-chip oil reservoir. Pneumatic actuation of the MDT membranes was performed using a nominal pressure of 20 psi. When using multi-step actuation to avoid unwanted droplet splitting when ejecting larger droplets from a trap, the pressure was first set to 3.5 psi, and increased to 20 psi under software control when the droplet was observed to begin exiting the trap.

### Droplet Detection

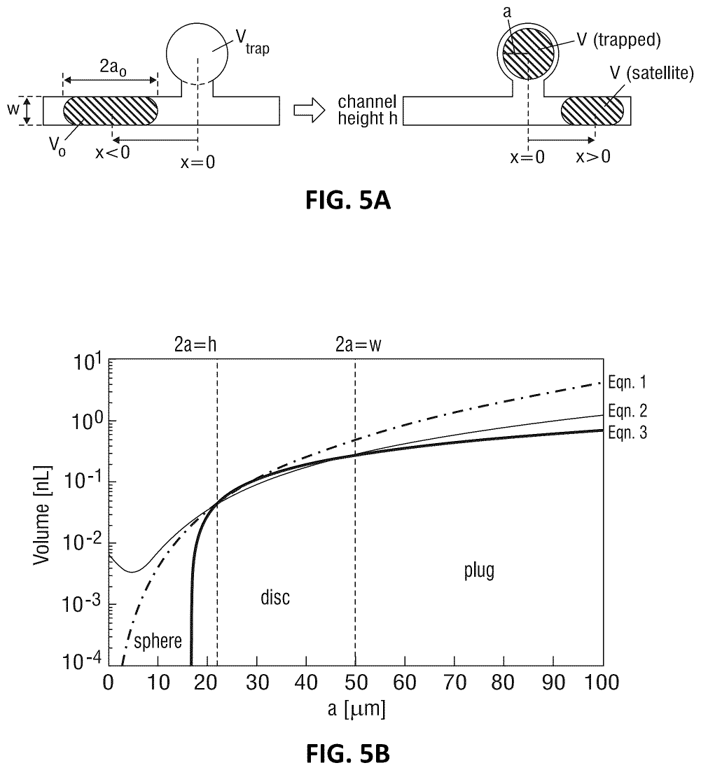

As shown in FIG. 5A, droplet centroid position, length, and width can be monitored and may be accessed within the system control software (e.g., FluidScript), thereby allowing accurate droplet volumes to be determined in the user-defined script. For example, droplet tracking was performed via custom vision system code written in Python using the cross-platform OpenCV image processing library, and the resulting system was capable of real-time tracking of multiple droplets at approximately 50 frames per second with an image resolution of 640×480 pixels. The vision system's blob detection algorithm yielded geometry data for the projection of a droplet onto the chip surface.

To extract droplet volume from this information, the three-dimensional shape of the droplet can be estimated. There are multiple possible morphologies for a droplet, depending on its size and location within the MDT device. Referring to the channel and trap geometry presented in FIG. 5A, the flow network includes a main channel of width w and height h, with h<w, and the planar projection of a droplet has a major axis length of 2a. In the case of a small spherical aqueous volume, with radius, a, smaller than half the channel height (0<a≤h/2), the volume may be directly determined from its radius via Eqn. 1:

$$V = \frac{4}{3} π {a}^{3} \qquad ( 1 )$$

As the radius grows beyond h/2, the droplet becomes constrained by the upper and lower channel surfaces, resulting in a disc with a semi-toroidal perimeter. Under the assumption that the oil lubrication layer between the water phase and channel surfaces prevents wetting of the channel walls, the droplet volume for this configuration is found by integration to yield the expression presented in Eqn. 2, which is valid over h<2a≤w for a droplet in the main channel, and h<2a≤2R for a droplet volume captured within a trap:

$$V = \frac{π h}{24} [ 24 {a}^{2} + 6 h ( π - 4 ) a - {h}^{2} ( 3 π - 10 ) ] \qquad ( 2 )$$

For a droplet within the main channel, any further increase in volume (a>w/2) will lead to the formation of an oblong plug with ends possessing two-dimensional curvature defined by interactions with the channel walls in both the width and height dimensions. The plug volume in this case may be approximated by Eqn. 3:

$$V = [ hw - ( 4 - π ) {( \frac{2}{h} + \frac{2}{w} )}^{- 2} ] ( 2 a - \frac{w}{3} ) \qquad ( 3 )$$

A summary of the valid regions for each expression is provided in FIG. 5B. For each droplet tracked by the vision system, the value of a can be extracted from the image data and used to determine the droplet morphology, followed by application of appropriate expression from Eqns. (1)-(3) to calculate the estimated droplet volume.

Time delays introduced by the software and hardware used for image capture, computation, and valve actuation can lead to errors between the imaged droplet position and actual position at the time of trap membrane actuation. The primary source of latency (λ) within the MDT system is mechanical compliance within the pneumatic system used to control the on-chip valves, including air compressibility, compliance within the tubing connecting the pressure source with the chip inlets, and compliance associated with the elastomeric chip itself, while secondary sources of latency include camera frame rate limitations and delays resulting from processing speed limitations for the OpenCV code. To account for error between the reported and actual droplet positions, the vision system code can extract droplet velocity (u) and observed position (x_{obs}) from the measurements, and can estimate the true droplet position (x) as x=x_{obs}+uλ at each measurement time point. Because velocity and position can be continually monitored for all droplets within the user-defined detection regions, this approach can ensure that accurate position estimates are generated regardless of flow velocity.

While latency remained constant for a given experimental configuration, changes in tubing connections or off-chip pneumatic valve apparatus resulted in variations in the observed time delay. Total latency for the given configuration was determined before implementing any experiments by generating a sequence of droplets with volume significantly smaller than the static trap volume and capturing these droplets with a random distribution for x_{obs}. Because the distribution of capture events is expected to be symmetric about x=0 due to the low flow rate within the main channel, latency can be directly quantified from asymmetry of the measured data. Using this approach, estimated latency for all experiments reported herein ranged from λ=50-200 ms.

### Droplet Generation

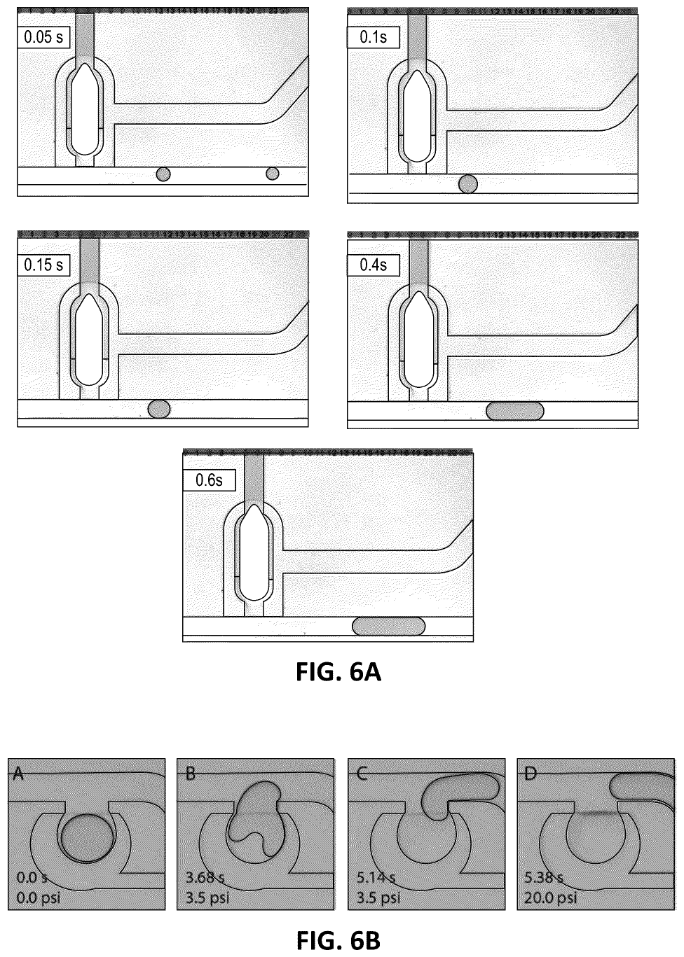

Software-defined droplet manipulation combined the flexibility of robotic microplate systems with microfluidics, enabling the execution of complex sequences of on-chip sample and reagent handling steps that can take advantage of the unique capabilities of microfluidic technology. Initial droplets were generated by using a membrane valve to gate a dispersed aqueous phase into a continuous-phase oil flow at a microfluidic T-junction, providing an effective method for precise software-defined control over droplet timing and volume. To establish the relationship between valve timing and droplet volume, experiments were performed at different continuous phase flow rates and gating valve opening times, with the resulting droplet volumes determined from the automated imaging code. An example of droplet generation with valve dwell time increasing from 50 ms to 600 ms is reflected in the sequence of images of FIG. 6A. In the experiment, three droplets were generated for each valve dwell time to demonstrate repeatable volume control. Droplets ranging from 80 pL to 2 nL were reliably formed, with relative standard deviation below 5% over the full volume range. The oblong valve body used by the droplet generator prevents leakage while the valve is in its off state owing to the high Laplace pressure imposed by the long and narrow side gaps along the edges of the valve body, allowing reliable flow control without the need for complete sealing of the valve seat. Alternatively or additionally, droplets can be generated by filling the main channel and MDT elements with an aqueous phase, and then replacing the aqueous phase in the main channel with oil while retaining the aqueous phase in the MDT chambers, thereby resulting in the formation of water droplets within the MDTs.

### Droplet Capture

Following droplet generation, the membrane displacement traps enabled multiple functions including droplet capture, ejection, splitting, and merging. Software-controlled automation of these steps required that appropriate valve timings for each action be determined. To investigate the impact of actuation timing on each unit operation, the automated system was programmed to implement each droplet manipulation step with random timing while tracking the resulting event. The first operation explored was the capture of droplets with initial volume (Vₒ) smaller than the static trap chamber volume (Vₜᵣₐₚ). The trap volume was defined by a cylinder with radius and height of the trap chamber and does not include the volume of the entrance neck. In practice, the maximum volume that can be isolated within the trap without protruding into the main channel flow is less than the full trap volume, since deforming a droplet into the trap neck increases the interfacial free energy less than filling the internal corners of the trap chamber as the droplet volume expands.

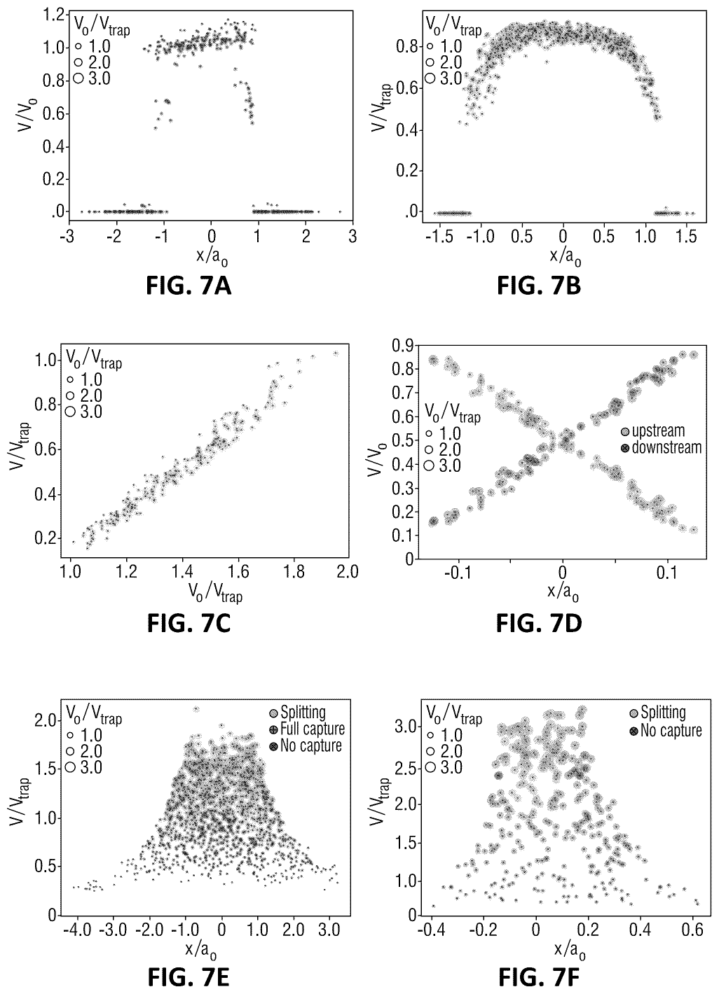

A sequence of droplets was generated with different half-length values (aₒ) between 58-164 μm, corresponding to volumes ranging from 0.35-1.25 nL. A single MDT trap was actuated with the droplet center located a distance x from the midline of the trap entrance, with x constrained to the range |x/aₒ|<3. To avoid experimental bias, values for trap opening position and droplet volume within the sequence were randomized. The resulting data is presented in FIG. 7A. Full droplet capture was achieved for |x/aₒ|<1, with a steep loss in capture efficiency outside this range. While droplet capture was nearly binary, some splitting was observed at the transitions between capture states, with the split droplets clustered in regions with nearly equal volume between the parent and child droplets. Normalizing the position measurements by the static trap radius (a) was initially expected to serve as a suitable independent variable for the analysis of MDT actuator timing. However, it was found that normalizing by the half-length of the initial droplet (aₒ) significantly reduced variability in the resulting relationships. As a result, this normalization was used for all position data in FIGS. 7A-7E.

### Droplet Ejection

Once captured, droplets were ejected from their traps by actuating the MDT membrane to reduce the trap volume and force the contents into the main channel. At the main channel flow rate used here, the change in trap volume was sufficiently rapid to expel the droplet without generating satellite droplets by flow-induced shearing. For example, a capture and ejection sequence was successfully performed for a 0.44 nL droplet. When ejecting larger droplets approaching the maximum trap volume, rapidly switching the MDT control line pressure to its peak value occasionally resulted in droplet splitting, with a portion of the initial droplet remaining within the trap after completing the ejection step. This behavior occurs when the larger droplets are unable to fully exit the trap before the actuator membrane reaches its final position, resulting in pinching of the droplet tail from the ejected volume. To prevent unwanted droplet splitting, a two-stage ejection technique was employed in later experiments. As shown in FIG. 6B, in this process, the pressure was first increased to 3.5 psi to partially expel the droplet from the trap while using the vision system to monitor the position of the droplet tail. When the tail neared the trap exit, the MDT control line pressure was increased to 20 psi. This two-step pressurization process reduces the effective capillary number during ejection and enables reliable droplet removal from the trap without splitting.

### DROPLET SPLITTING

Droplet splitting can be performed by capturing an initial droplet with volume greater than the trap chamber volume (FIG. 7B), resulting in a child droplet with volume given approximately by Vₒ−Vₜᵣₐₚ. In this case, the trap actuation timing was defined to select the desired portion of the droplet to be captured, with the secondary satellite droplet formed during splitting remaining in the main channel for later isolation in a downstream trap. Timing of the actuation step, together with the initial droplet volume, dictates the volume of the resulting primary and satellite droplets. The partial-capture process was studied by generating large droplets with Vₒ>Vₜᵣₐₚ and attempting to trap these droplets at different positions while monitoring the parent and child droplet volumes generated by each splitting event. As with the previous experiments investigating the full capture of smaller droplets, the sequence of droplet volumes and actuation times was randomized. Initial droplets in this experiment possessed half-lengths between 181-365 μm, corresponding to volumes ranging from 1.40-2.95 nL.

The relationship between trapped volume and droplet position is presented in FIG. 7B, with captured volume normalized to the static trap volume. As seen in FIG. 7B, droplet capture events within the range of |x/aₒ|<0.5 tend to result in complete filling of the trap, ensuring a predictable volume for child droplets formed during the partial capture process. To confirm this expectation, droplets remaining in the main channel following each partial capture event when |x/aₒ|<0.5 were analyzed, as shown in FIG. 7C. As expected, the resulting satellite droplet volume scales linearly with the initial droplet volume.

In the partial-capture droplet splitting technique, the resulting satellite droplets remain intact, with no secondary splitting events observed. A minimum satellite droplet volume of approximately 0.2Vₜᵣₐₚ was achieved using this technique. Because the droplet splitting process was largely analogous to droplet generation in a T-junction channel geometry, the lower bound for satellite droplet volume was expected to depend on the hydrostatic pressures within the oil and water phases. As a result, the minimum satellite droplet volume was largely dependent on the channel and trap neck geometry, rather than the capillary number of the flow. Applications requiring smaller satellite droplets may thus benefit by reducing the main channel height and minimizing the trap neck width.

As an alternative to partial capture for droplet splitting, a larger sample plug can also be split into two separate volumes by ejecting oil from an actuated trap as the plug traverses the trap opening (FIG. 7C), destabilizing the droplet interface and generating a pair of satellite droplets on either side of the trap neck. The volume of each child droplet was controlled by adjusting the timing of the oil ejection step. Droplet splitting data from a set of several hundred oil ejection events is presented in FIG. 7D. Compared with the partial capture method of droplet splitting, oil ejection provided improved precision for the resulting satellite volumes with low variance. After splitting, the resulting satellite droplets were also readily recaptured in subsequent traps. However, the oil ejection approach was only effective for plugs with initial volume greater than nearly twice the trap volume, with smaller droplets displaced within the channel instead of splitting regardless of position during oil ejection. This constraint was imposed by the trap neck width and main channel width, with reduced width values expected to enable the splitting of smaller droplets by oil ejection. Furthermore, droplet splitting could only be achieved in a narrow range of droplet position, with the initial droplet centroid located within approximately 15% of its half-width from the trap midline. Actuating the MDT trap outside this window resulted in displacement of the intact droplet within the main channel without splitting.

Overall performance of the different splitting techniques can also be seen in the domain maps for partial capture and oil ejection presented in FIGS. 7E-7F, respectively. These plots display the range of initial droplet volumes and trap actuation positions that yield full droplet capture or droplet splitting for each unit operation. Significantly, the boundaries defining each domain were distinct and displayed minimal overlap. These domains are expected to be design-dependent, and changes to the channel or trap geometry may result in different operational regions. Thus, new MDT chip designs should be recharacterized to determine appropriate operation regimes and develop new analytic relationships to define actuation times for specific droplet manipulation steps.

### Droplet Merging

The controlled mixing of discrete fluid volumes is a fundamental step for many chemical and biological assays, allowing fluids with different compositions to be combined at specific time points. Passive droplet merging has been widely demonstrated in microfluidic flow systems by employing various geometries to bring droplets into interfacial contact either during flow or while confined in a static microwell, allowing them to merge and mix after draining the oil lubrication layer between the droplets. To achieve droplet mixing within the automated MDT arrays, multiple droplets were isolated together within a single trap, thereby forcing the paired droplets into close proximity to promote interfacial contact and merging.

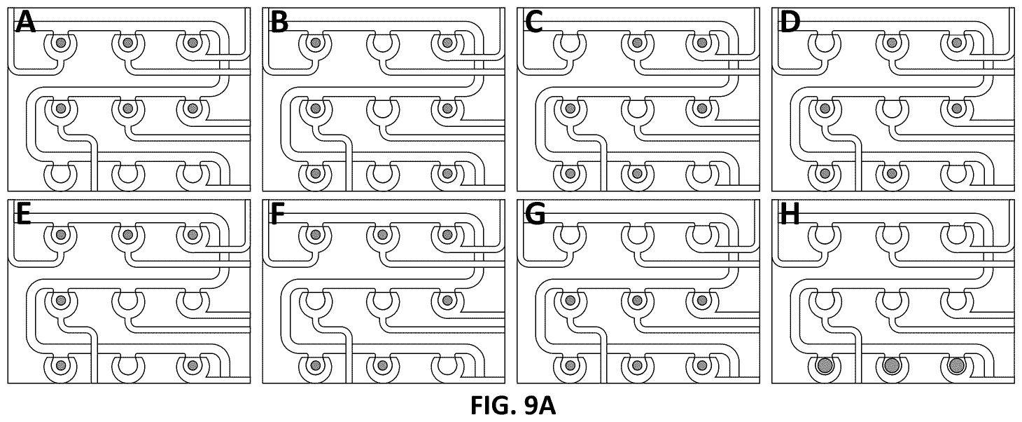

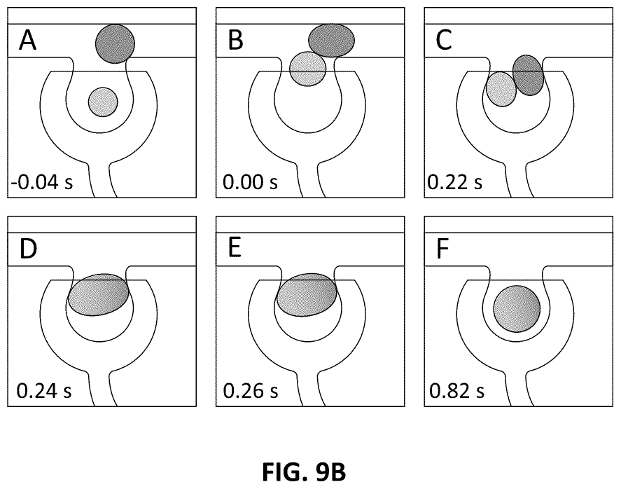

Following an initial droplet trapping step, a second droplet was captured within the same well by partially actuating the membrane with an applied pressure of 2.5 psi before the target droplet reached the trap, thereby reducing the trap volume without ejecting the initial droplet. As the second droplet reached the trap entrance, the pressure was released, pulling the droplet partially into the trap and spatially confining the droplet pair to facilitate interfacial contact and ultimately fusing after draining the oil layer between the droplets. The processes of oil draining and droplet merging were observed to be nearly instantaneous for larger droplets with a combined volume approaching Vₜᵣₐₚ, while smaller droplets often required several seconds after coming into contact within the trap before merging. A sequence of repeated droplet merging events was successfully performed, as shown in FIG. 9B.

### Flow Reversal

The bidirectional valve configuration can enable rapid switching of flow direction within the MDT array. Topologically, the flow circuit included two pairs of membrane valves positioned within a loop connecting the inlet and waste ports, and intersecting the MDT flow path on either side of the array, as shown in FIGS. 2B-2D. When actuated with a pair of inverted pressure inputs to hold one set of valves open and the other set closed, the two sets of valves serve to toggle between the opposing flow paths through the MDT array. The use of an off-chip 3-way pneumatic valve to select the pressure applied to both sets of valves from a single control output provides a convenient approach for changing the flow direction. Compared to the use of multiple off-chip pumps and valves to change the flow direction, the H-bridge design significantly reduced system complexity, and was found to effectively minimize the fluidic dead volume and eliminate pressure perturbations during flow switching. Rapid reversal in flow direction was achieved, with measurements of switching speed limited only by the camera frame rate. The utility of flow reversal for manipulating droplets within the MDT array is reflected in the sequence of images shown in FIG. 9A.

### Flow Rate

Maximum droplet processing speed in the MDT array can be constrained by the flow rate used to mobilize droplets in the main channel. For the fabricated examples described herein, droplet handling steps were performed at a bulk flow rate of ˜141 nL/min, corresponding to a flow velocity of ˜470 μm/s. One potential constraint limiting the flow rate is the capillary number (Ca) of the system, which scales with flow velocity. At higher capillary numbers, viscous forces can be sufficiently large relative to surface tension forces to impact droplet generation. Using an estimated interfacial tension value of 20 mN/m for the surfactant system, the resulting capillary number for flow in the main channel was calculated as Ca=2.1×10⁻⁵, well within the range of Ca<<0.01 reported for stable droplet formation in microchannels with similar geometry as the present MDT devices. This also suggests that a significantly higher flow rate range may be employed without sacrificing droplet stability. A more practical parameter limiting flow velocity is the vision system frame rate, which defines the spatial resolution for the droplet position measurements used for MDT actuation timing. At the given flow rate and video capture speed of 50 frames per second, average fluid displacement in the main channel between successive video frames was approximately 10 μm, introducing potentially significant errors in droplet position measurements.

### pH Gradient Generation

Sample solutions with different pH values were produced by electrolysis using a syringe pump (NE-8000, New Era Pump Systems, Farmingdale, NY) to withdraw tap water from a reaction vessel at a rate of 200 μL/min through a steel needle, to which 24 V was applied by a DC power supply. A second electrode, formed from bare wire and submerged alongside the needle, was connected to the ground terminal of the supply. Starting with a 20 mL sample volume, 10 mL was withdrawn during electrolysis to serve as an acid solution, leaving 10 mL in the reaction vessel to serve as a base solution. A pH indicator dye (UI-100, Micro Essential Labs, Brooklyn, NY) was added at 15% v/v to both solutions. The final pH values for the stock solutions were measured as pH 6.0 and 10.2, corresponding to solution colors of yellow and blue-green, respectively.

### Programmable pH Ladder Generation

Control over sample pH may be useful in applications such as, but not limited to, droplet-based cell culture, biomolecular separations, protein crystallization screening, and a wide range of chemical and biochemical assays. While pH in conventional droplet microfluidic platforms is typically defined by the buffer conditions used during droplet generation, the ability to actively and controllably adjust solution pH within individual droplets can provide significantly greater experimental flexibility and enable new operations that cannot be performed with static droplet platforms. Integrated mixers have been employed to actively adjust the pH in single-phase microfluidic systems, while techniques including on-chip electrochemical control and inter-droplet ion transport have been demonstrated for dynamic pH manipulation in droplet microfluidic platforms.

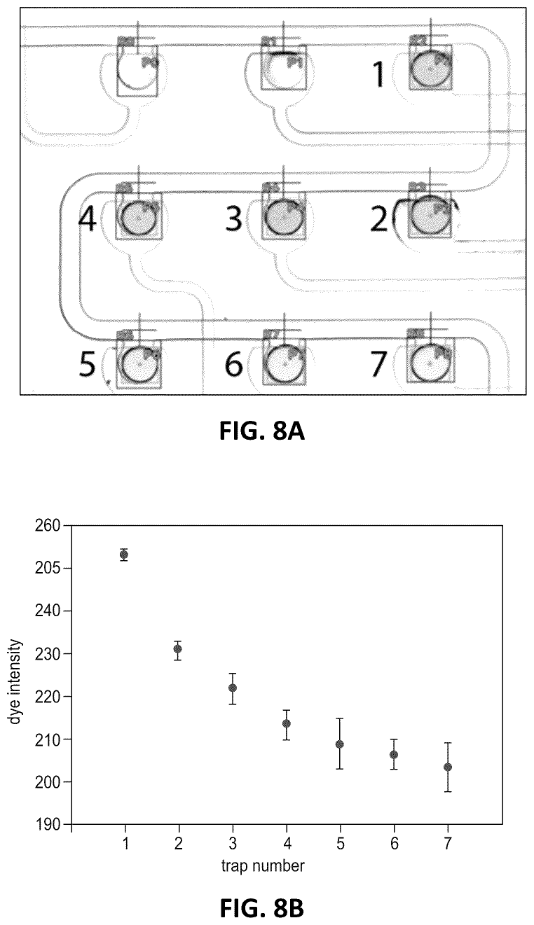

Automated droplet manipulation using the MDT arrays offers a new approach to this challenge. The combination of software-defined droplet generation, capture, splitting, and merging sequences with flexible control over sample flow direction within the array enables arbitrary mixing steps to be performed as part of a serial dilution process, thereby allowing initial droplets with high and low pH values to be metered and recombined to yield intermediate pH levels. To demonstrate this concept, cascade dilution was performed by combining droplet generation with repeated capture, splitting, and merging steps to form a 7-step pH ladder with a gradient ranging from pH 6 to pH 10.2. Starting with two sample solutions defining the desired pH range, individual nanoliter droplets with varying pH were generated through a sequence of up to 6 sequential droplet splitting steps and up to 3 merging steps, yielding final droplets containing different volume ratios of the initial solutions. Unused satellite droplets formed during the splitting steps were ejected through the inlet to minimize the potential for unwanted crosstalk between captured droplets. A logarithmic pH ladder was produced using this approach, as reflected in the resulting indicator dye intensities in FIGS. 8A-8B.

Beyond the specific droplet operations explored here, the MDT traps can support other automated functionalities. For example, metering of different sample volumes from a given trap may be achieved by applying variable pressure inputs to the pneumatic control line. It is also possible to eject a trapped droplet when a mobile droplet or sample plug traverses the trap opening, allowing the MDT to serve as a nanoinjector to merge the two volumes within the main channel. While this latter process often results in an initial droplet splitting event due to the co-ejection of both water and oil phases from the trap, the resulting oil film separating the resulting discrete volumes typically drains within several seconds to yield a single mixed droplet.

Droplets may also be delivered to an exit port for off-chip collection, allowing fluid volumes processed within the array to be extracted for characterization using conventional benchtop instrumentation. For example, flow cytometry techniques such as fluorescence-activated cell sorting may be employed on droplets ejected from an MDT array by first processing the collected droplets in a water/oil/water double emulsion generator prior to introduction into the cytometer. Alternatively, collected droplets can be analyzed by mass spectrometry.

The automated system may also be used for applications in droplet-based cell culture. Compared with water-in-oil emulsions employing mineral oil with non-ionic surfactant, long-term cell culture within droplets uses a gas-permeable fluorinated oil and biocompatible surfactant system to maintain cell viability. Droplets in fluorinated oil (FC-40) were successfully manipulated in an MDT array, with the generation, capture, and ejection of both small (0.3 nL) and large (1.0 nL) droplets achieved using an unmodified MDT chip. Cell cultures are possible within picoliter-scale droplets using a similar fluorinated oil and surfactant system. Thus, cell viability should be readily maintained within the larger nanoliter-scale droplets disclosed herein.

MDT arrays containing higher well counts can be used to further expand the utility of the technology. In the fabricated examples, array scaling was limited by the number of pneumatic inputs for MDT actuation, since each input requires a separate world-to-chip needle port for pressure control. In addition to significantly increasing fabrication complexity and reducing operational reliability, the chip real estate required for control port integration and pneumatic control line routing can quickly dominate the total device area. However, pneumatic microfluidic multiplexers can be used to provide control over large numbers of on-chip elastomer actuators with a minimal number of control inputs.

### CONCLUSION

Although particular materials, microfluidic chip, and microfluidic network configurations have been illustrated in the figures and discussed in detail herein, embodiments of the disclosed subject matter are not limited thereto. Indeed, one skilled in the art will readily appreciate that different materials, microfluidic chips, and/or microfluidic network configurations can be selected and/or components added to provide the same or similar effect. In practical implementations, embodiments may include additional components (fluidic or otherwise) or other variations beyond those illustrated. Accordingly, embodiments of the disclosed subject matter are not limited to the particular materials and configurations specifically illustrated and described herein

Any of the features illustrated or described herein, for example, with respect to FIGS. 1A-9B, can be combined with any other feature illustrated or described herein, for example, with respect to FIGS. 1A-9B, to provide fluid circuits, systems, devices, structures, methods, aspects, or embodiments not otherwise illustrated or specifically described herein. All features described herein are independent of one another and, except where structurally impossible, can be used in combination with any other feature described herein. In view of the many possible aspects to which the principles of the disclosed technology may be applied, it should be recognized that the illustrated features are only examples and should not be taken as limiting the scope of the disclosed technology. Rather, the scope is defined by the following claims. Applicant therefore claims all that comes within the scope and spirit of these claims.

1. A system comprising:
(a) a microfluidic chip comprising:
a microfluidic network comprising a main channel; and
a plurality of membrane displacement traps (MDTs) fluidically coupled to the main channel;
(b) an MDT actuation system configured to selectively actuate the plurality of MDTs;
(c) a pump fluidically connected to the microfluidic chip and configured to pump a fluid into the microfluidic network;
(d) a detection system configured to detect a position of one or more micro-objects within the microfluidic chip; and
(e) a control system operatively coupled to the MDT actuation system, the pump, and the detection system, the control system comprising one or more processors and one or more computer-readable storage media storing instructions that, when executed by the one or more processors, control the MDT actuation system and the pump to provide an operation on at least one of the one or more micro-objects based at least in part on data received from the detection system,
wherein the operation includes generating, capturing, splitting, releasing, or merging of the at least one of the one or more micro-objects.

2. The system of claim 1, wherein the one or more micro-objects comprise at least one water-in-oil-based or oil-in-water-based droplet.

3. The system of claim 1, wherein each MDT comprises:
a well;
a neck fluidically connecting the well to a respective portion of the main channel;
a membrane bounding at least part of the well and constructed to deform into the well so as to displace fluid from the well; and
a pressure line in fluid communication with a side of the membrane opposite the well and configured to transmit hydraulic pressure to the membrane so as to deform the membrane into the well.

4. The system of claim 3, wherein the MDT actuation system is operatively coupled to the pressure lines of the plurality of MDTs and configured to selectively apply the hydraulic pressure thereto.

5. The system of claim 3, wherein the microfluidic chip comprises:
a fluidic layer defining, at least in part, the wells, the necks, and the main channel; and
a control layer coupled to the fluidic layer and defining, at least in part, the pressure lines and the membranes.

6. The system of claim 5, wherein the control layer, the fluidic layer, or both are formed of an elastomeric polymer and/or an oxygen-permeable polymer.

7. The system of claim 5, wherein the control layer, the fluidic layer, or both are formed of polydimethylsiloxane (PDMS).

8. The system of claim 1, wherein:
the microfluidic network comprises an H-bridge circuit formed by a plurality of channels fluidically coupled to the main channel;
a first input channel of the plurality of channels being coupled between a first end of the main channel and an inlet to the microfluidic network;
a second input channel of the plurality of channels being coupled between a second end of the main channel and the inlet;
a first output channel of the plurality of channels being coupled between the first end of the main channel and an outlet from the microfluidic network; and
a second output channel of the plurality of channels being coupled between the second end of the main channel and the outlet.

9. The system of claim 8, further comprising:
an H-bridge actuation system coupled to the H-bridge circuit and constructed to control operation of the H-bridge circuit,
wherein the control system is operatively coupled to the H-bridge actuation system, and the one or more computer-readable storage media store additional instructions that, when executed by the one or more processors, control the H-bridge actuation system and the pump to change a direction of fluid flow through the main channel.

10. The system of claim 9, wherein:
the H-bridge actuation system comprises:
a first valve operatively coupled to the first input channel and configured to control fluid flow therethrough;
a second valve operatively coupled to the second input channel and configured to control fluid flow therethrough;
a third valve operatively coupled to the first output channel and configured to control fluid flow therethrough; and
a fourth valve operatively coupled to the second output channel and configured to control fluid flow therethrough; and
the one or more computer-readable storage media store instructions that, when executed by the one or more processors, control the H-bridge actuation system to:
cause fluid to flow in a first direction through the main channel by opening the first and third valves and closing the second and fourth valves; and
cause fluid to flow in a second direction through the main channel by closing the first and third valves and opening the second and fourth valves.

11. The system of claim 1, further comprising means for injecting the one or more micro-objects into a fluid flowing into or within the microfluidic network.

12. The system of claim 11, wherein the means for injecting includes one or more droplet generators, each droplet generator comprising a T-junction coupled to a membrane valve.

13. The system of claim 1, wherein the detection system comprises a vision system configured to image at least part of the plurality of MDTs and/or the main channel.

14. A system comprising:
a microfluidic network comprising a first channel and an H-bridge circuit formed by a plurality of second channels fluidically coupled to the first channel; and
an H-bridge actuation system coupled to the H-bridge circuit and constructed to control operation of the H-bridge circuit,
wherein a first input channel of the plurality of second channels is coupled between a first end of the first channel and an inlet to the microfluidic network,
a second input channel of the plurality of second channels is coupled between a second end of the first channel and the inlet,
a first output channel of the plurality of second channels is coupled between the first end of the first channel and an outlet from the microfluidic network, and
a second output channel of the plurality of second channels is coupled between the second end of the first channel and the outlet.

15. The system of claim 14, further comprising:
a pump fluidically connected to the inlet to the microfluidic network and configured to pump a fluid into the microfluidic network; and
a control system operatively coupled to the pump and the H-bridge actuation system, the control system comprising one or more processors and one or more computer-readable storage media storing instructions that, when executed by the one or more processors, control the H-bridge actuation system and the pump to change a direction of fluid flow through the first channel.

16. The system of claim 15, wherein:
the H-bridge actuation system comprises:
a first valve operatively coupled to the first input channel and configured to control fluid flow therethrough;
a second valve operatively coupled to the second input channel and configured to control fluid flow therethrough;
a third valve operatively coupled to the first output channel and configured to control fluid flow therethrough; and
a fourth valve operatively coupled to the second output channel and configured to control fluid flow therethrough; and
the one or more computer-readable storage media store instructions that, when executed by the one or more processors, control the H-bridge actuation system to:
cause fluid to flow in a first direction through the first channel by opening the first and third valves and closing the second and fourth valves; and
cause fluid to flow in a second direction through the first channel by closing the first and third valves and opening the second and fourth valves.

17. The system of claim 14, wherein:
the microfluidic network further comprises a plurality of membrane displacement traps (MDTs) fluidically coupled to the first channel, and
each MDT comprises:
a well;
a neck fluidically connecting the well to a respective portion of the first channel;
a membrane bounding at least part of the well and constructed to deform into the well so as to displace fluid from the well; and
a pressure line in fluid communication with a side of the membrane opposite the well and configured to transmit hydraulic pressure to the membrane so as to deform the membrane into the well.

18. A method comprising:
detecting, via a detection system, a position of one or more micro-objects within a microfluidic chip, the microfluidic chip comprising a microfluidic network and a plurality of membrane displacement traps (MDTs), the microfluidic network comprising a main channel, each MDT being coupled to the main channel; and
controlling, via a control system operatively coupled to the detection system, fluid flow through the main channel and actuation of one or more of the plurality of MDTs to perform an operation on at least one of the one or more micro-objects based at least in part on the detecting,
wherein the operation includes generating, capturing, splitting, releasing, or merging of the at least one of the one or more micro-objects.

19. The method of claim 18, wherein:
each MDT comprises:
a well;
a neck fluidically connecting the well to a respective portion of the main channel;
a membrane bounding at least part of the well and constructed to deform into the well so as to displace fluid from the well; and
a pressure line in fluid communication with a side of the membrane opposite the well and configured to transmit hydraulic pressure to the membrane so as to deform the membrane into the well; and
the controlling actuation of the one or more of the plurality of MDTs comprises applying hydraulic pressure to the respective pressure line of the one or more of the plurality of MDTs.

20. The method of claim 18, wherein:
the microfluidic network further comprises an H-bridge circuit formed by a plurality of channels fluidically coupled to the main channel; and
the controlling fluid flow through the main channel comprises changing a direction of the fluid flow through the main channel via the H-bridge circuit.
